(19) United States
(12) Patent Application Publication
(10) Pub. No.: US 2013/0185148 A1
(43) Pub. Date: Jul. 18, 2013

(54) SYSTEMS, METHODS, APPARATUSES, AND COMPUTER PROGRAM PRODUCTS FOR PROVIDING SERVICES ON AN AUTOMATED TELLER MACHINE

(71) Applicant: Clinton Townsend, Brooklyn, NY (US)

(72) Inventor: Clinton Townsend, Brooklyn, NY (US)

(21) Appl. No.: 13/741,035

(22) Filed: Jan. 14, 2013

Related U.S. Application Data
(60) Provisional application No. 61/586,437, filed on Jan. 13, 2012.
(60) Provisional application No. 61/622,118, filed on Apr. 10, 2012.

(51) Int. Cl. G06Q 30/02

(52) U.S. Cl. CPC G06Q 30/0251; G06Q 20/1085
USPC 705/14.49; 705/14.4

(57) ABSTRACT

A method for providing surcharge-free ATM transactions is provided. The method may include providing ATM transaction services to an ATM user. The method may further include causing third-party advertising to be presented to the user during the ATM transaction in lieu of charging a surcharge fee for the ATM transaction. A corresponding system, apparatus, and computer program product are also provided.

### RELATED APPLICATIONS

This application claims the benefit of U.S. Provisional Application No. 61/586,437, filed on Jan. 13, 2012 and U.S. Provisional Application No. 61/622,118, filed on Apr. 10, 2012, both of which are incorporated herein by reference in their entirety.

### TECHNOLOGICAL FIELD

Embodiments of the present invention relate generally to computer-provided consumer services and, more particularly, relate to systems, methods, apparatuses, and computer program products for providing services on an automated teller machine (ATM).

### BACKGROUND

Consumers regularly use ATM machines to carry out a variety of financial transactions, such as withdrawal of cash from bank accounts. On average, the American consumer uses an ATM 10 times per month. Consequently, ATM machines are widely dispersed in a variety of locations to enable consumers to engage in financial transactions on demand.

A network of ATM machines that may be provided by a user's financial services provider may be used by the user without incurring a surcharge. However, the coverage of the financial services provider's ATM network may not be global in that the financial services provider may not have an ATM machine convenient to a user's location. As such, a user may have to use an ATM machine operated by an entity other than the user's financial services provider, which may charge the user a surcharge for use of the ATM machine. On average this surcharge may be about $2.40 per transaction. Accordingly, the average ATM user may incur $24 per month in ATM surcharges if he or she uses ATM machines that are not operated by his or her financial services provider.

Some ATM machine operators do provide surcharge free ATMs. However, these existing surcharge-free ATMs are not truly surcharge-free, as the ATM transaction fee surcharge may be paid to the ATM operator on behalf of the user by the user's financial services provider. Accordingly, costs of the ATM surcharge may still be passed onto the customer by his or her financial services provider in the form of higher fees for financial services that may offset the costs of the ATM surcharges paid by the financial services provider.

### BRIEF SUMMARY OF EXAMPLE EMBODIMENTS

Systems, methods, apparatuses and computer program products are provided herein for providing services on an ATM. Embodiments provided herein may provide several advantages to financial services providers, ATM operators, ATM users, and advertisers. Some example embodiments provide a surcharge-free ATM that may be used by a cardholder of any financial services provider. Accordingly, some example embodiments benefit ATM users by eliminating transaction surcharges. More particularly, some example embodiments integrate third-party advertising capabilities into ATM machines, so as to transform a traditional Automated Teller Machine into an interactive out-of-home digital advertising platform. The use of an ATM machine as a digital advertising platform in some example embodiments provides for subsidization of transaction costs through advertiser revenue such that consumers may be provided with access to a surcharge-free ATM services. Some example embodiments integrate the landscape of the ATM industry and the greater infrastructure of the traditional banking and self-service industries.

Some example embodiments provide for targeted advertising via ATM machines. In this regard, some example embodiments provide advertising targeted to specific users, by demographics associated within a location in which an ATM machine is deployed, by time of day, day of week, some combination thereof, or the like. Accordingly, some example embodiments may provide for syndication of advertising content by driving content to targeted ATMs based on advertiser's needs at any moment. Some example embodiments collect customer data by tracking consumer transactions and purchases, accessing customer information from social network tie-ins, and/or the like, which may be used to target advertising and promotional offers to users based on their previous history and known interest.

Some example embodiments provide printed coupons and digital daily deal that may encourage consumers to spend more given the spending power created from free withdrawals. In accordance with some example embodiments, customers will be able to see a daily deal and/or an advertisement during the ATM transaction and be able to either purchase a promoted product or service on site at the ATM machine or request a follow up by inputting their contact information into the ATM.

Some example embodiments leverage the captive audience of users of ATM machines to allow national and/or local brands to create brand awareness about new products, specials, etc. Such example embodiments may provide ATM users with a more informed and targeted message from the advertiser.

Some example embodiments provide ATM machines configured to function as an interactive kiosk allowing users to purchase products or services. The convenience of e-commerce services provided by such example embodiments allows users to purchase products or services on demand in locations such as hotels, transportation hubs, and other locations in which ATM machines may be placed.

ATM machines provide by some example embodiments provide local communities with a means to communicate news or event information, such as information about concerts; school closings; emergency messages from local, state or federal officials; and/or the like to members of those communities.

In a first example embodiment, a method for providing surcharge-free ATM transactions is provided. The method of this example embodiment may comprise providing ATM transaction services to an ATM user. The method of this example embodiment may further comprise causing third-party advertising to be presented to the user during the ATM transaction in lieu of charging a surcharge fee for the ATM transaction.

In a second example embodiment, an apparatus for providing surcharge-free ATM transactions is provided. The apparatus of this example embodiment may comprise processing circuitry that may be configured to cause the apparatus of this example embodiment to at least provide ATM transaction services to an ATM user. The processing circuitry may be further configured to cause the apparatus of this example embodiment to cause third-party advertising to be presented to the user during the ATM transaction in lieu of charging a surcharge fee for the ATM transaction.

In a third example embodiment, a computer program product for providing surcharge-free ATM transactions is provided. The computer program product of this example embodiment may comprise at least one non-transitory computer-readable storage medium having computer-readable program code instructions stored therein. The computer-readable program code instructions of this example embodiment may include program code instructions configured to cause an apparatus to provide ATM transaction services to an ATM user. The computer-readable program code instructions of this example embodiment may also include program code instructions configured to cause third-party advertising to be presented to the user during the ATM transaction in lieu of charging a surcharge fee for the ATM transaction.

In a fourth example embodiment, an apparatus for providing surcharge-free ATM transactions is provided. The apparatus of this example embodiment may comprise means for providing ATM transaction services to an ATM user. The apparatus of this example embodiment may further comprise means for causing third-party advertising to be presented to the user during the ATM transaction in lieu of charging a surcharge fee for the ATM transaction.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for providing services on an ATM according to some example embodiments;

FIG. 2 illustrates a block diagram of an ATM apparatus in accordance with some example embodiments;

FIG. 3 illustrates a block diagram of a backend apparatus in accordance with some example embodiments;

FIG. 4 illustrates a block diagram of a mobile device in accordance with some example embodiments;

FIG. 5 illustrates a flowchart according to an example method for providing surcharge-free ATM transactions according to some example embodiments; and

FIG. 6 illustrates a flowchart according to another example method for providing surcharge-free ATM transactions according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

### System Overview

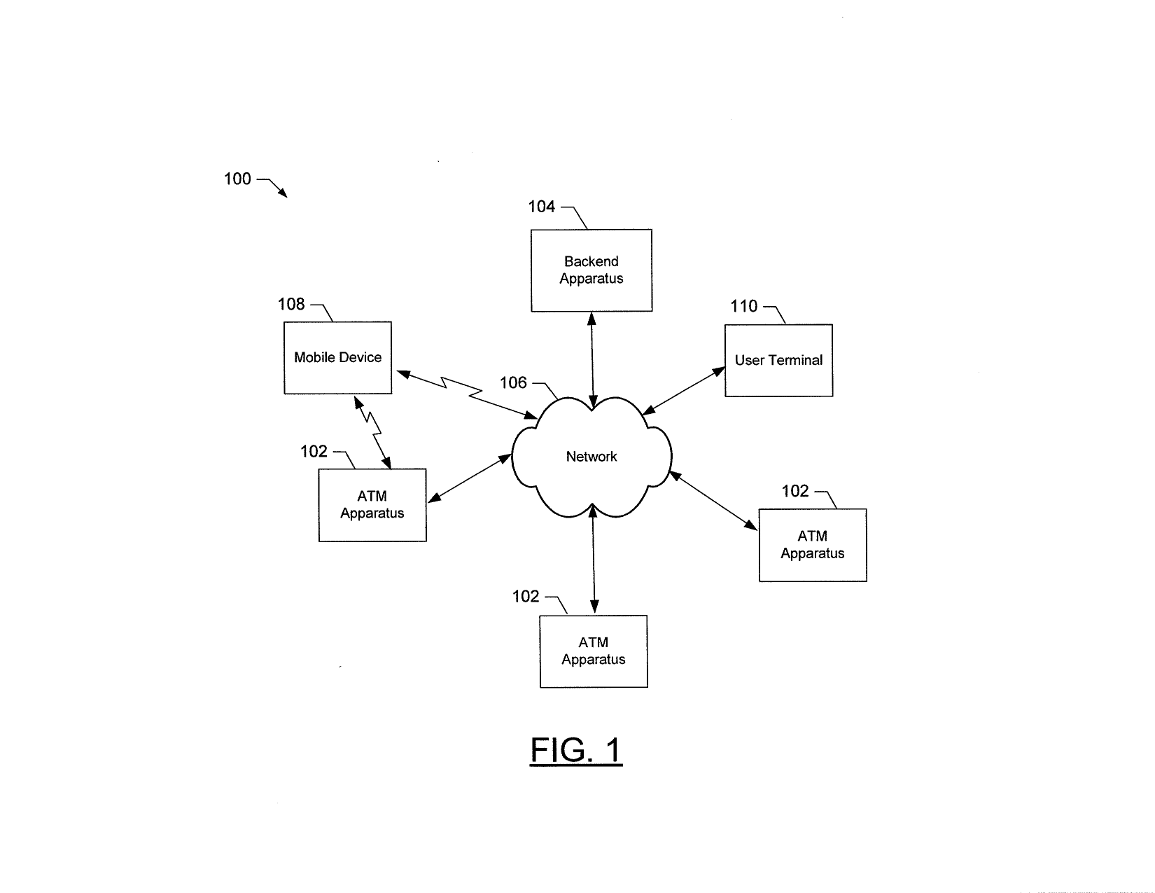

FIG. 1 illustrates a system 100 for providing services on an ATM according to some example embodiments. It will be appreciated that the system 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing services on an ATM, numerous other configurations may also be used to implement embodiments of the present invention.

The system 100 may include one or more ATM apparatuses 102. While three such ATM apparatuses 102 are illustrated in FIG. 1, it will be appreciated that this illustration is by way of example, and not by way of limitation, as the system 100 may include additional or fewer ATM apparatuses 102. An ATM apparatus 102 may comprise any computing device configured to provide ATM transaction services. As will be described further herein below, in some example embodiments, an ATM apparatus 102 may be configured to present advertising to ATM users in order to support the provision of surcharge-free ATM transaction services. Additionally or alternatively, as will be described further herein below, in some example embodiments, an ATM apparatus 102 may be configured to function as a services kiosk through which a user may purchase products, services, offers, and/or the like (interchangeably referred to herein as “products”).

The system 100 may further include a backend apparatus 104. The backend apparatus 104 may be embodied as one or more desktop computers, one or more laptop computers, one or more workstations, one or more network nodes, one or more servers, a server cluster, a cloud computing infrastructure, multiple computing devices in communication with each other, any combination thereof, and/or the like. The backend apparatus 104 may be configured to support a network of one or more ATM apparatuses 102. For example, the backend apparatus 104 may be configured in some example embodiments to support the processing of ATM transactions that may be initiated via an ATM apparatus 102. In this regard, the backend apparatus 104 may be configured to interface with computing systems of financial service providers, such as over the network 106, in order to facilitate account withdrawals, deposits, and/or other financial transactions that may be carried out on an ATM apparatus 102. Additionally or alternatively, in some example embodiments, the backend apparatus 104 may be configured to drive advertising content to an ATM apparatus 102, which may be presented to a user of the ATM apparatus 102.

The backend apparatus 104 may be configured to communicate with one or more ATM apparatuses 102 over the network 106 in order to support operation of the ATM apparatuses 102. The network 106 may comprise any data network that may facilitate the communication of data between the backend apparatus 104 and an ATM apparatus 102. By way of non-limiting example, the network 106 may comprise a wireline network, wireless network (e.g., a cellular network, wireless local area network, wireless wide area network, some combination thereof, or the like), or a combination thereof, and in some example embodiments comprises at least a portion of the Internet.

In some example embodiments, the system 100 may optionally comprise one or more mobile devices 108. By way of non-limiting example, a mobile device 108 may be embodied as a tablet computing device, mobile computer, smart phone, mobile communication device, digital camera/camcorder, mobile audio/video player, mobile digital video recorder, chipset, any combination thereof, and/or the like.

In some example embodiments, a mobile device 108 may be configured to connect to the network 106 to access information about the network of ATM apparatuses 102 in the system 100. This information may, for example, be accessed by a web interface that may be provided by the backend apparatus 104 in some example embodiments. Additionally or alternatively, the information may, for example, be accessed via an application that may be provided by some example embodiments, which may be implemented on a mobile device 108. By way of non-limiting example, information about the network of ATM apparatuses that may be accessed in accordance with various example embodiments may include locations of ATM apparatuses 102, product offerings that may be purchased at various ATM apparatuses 102, and/or the like.

In some example embodiments, a mobile device 108 may be configured to wirelessly interface with an ATM apparatus 102, such as via a Bluetooth connection, radio frequency (RF) connection, infrared (IR) connection, wireless universal serial bus (USB) connection, wireless local area network (WLAN) connection, and/or the like. In this regard, in some example embodiments, a mobile device 108 and ATM apparatus 102 may be configured to interface such that a user may assert his or her identity to the ATM apparatus 102 via an identifier that may be associated with his or her mobile device 108. Additionally or alternatively, the ATM apparatus 102 may be configured to interface with a user's mobile device 108 to communicate transaction data, digital coupons or vouchers for products, and/or the like to a mobile device 108.

In some example embodiments, the system 100 may additionally comprise one or more user terminals 110. A user terminal 110 may comprise any computing device that may be configured to connect to the network 106, such as to access information about the network of ATM apparatuses 102 in the system 100. For example, a user terminal 110 may be configured to access a web interface that may be provided by the backend apparatus 104 in some example embodiments to facilitate user interaction with the interface to retrieve information about the network of ATM apparatuses 102, purchase product offerings that may be associated with the network of ATM apparatuses 102, and/or the like. By way of non-limiting example, a user terminal 110 may be embodied as a desktop computer, laptop computer, tablet computing device, mobile phone, and/or the like.

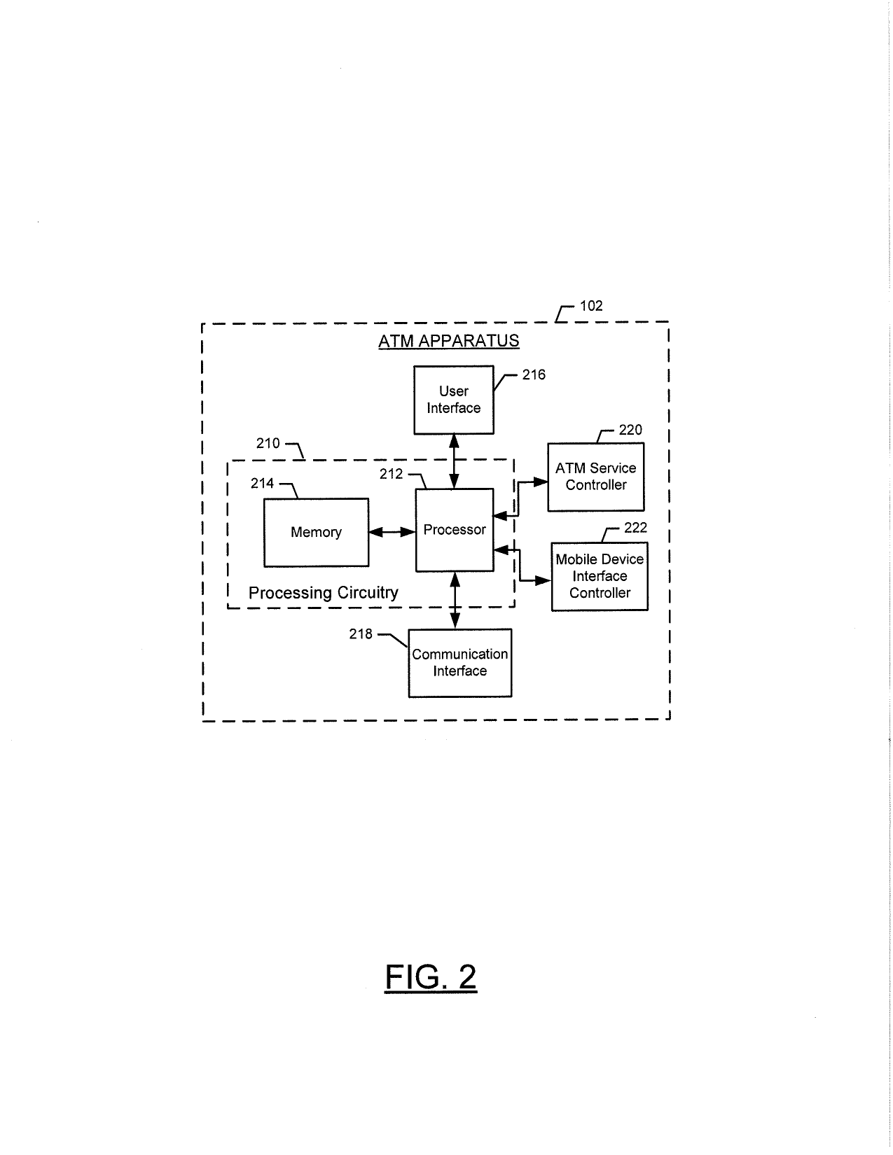

FIG. 2 illustrates a block diagram of an ATM apparatus 102 in accordance with some example embodiments. However, it should be noted that the components, devices or elements illustrated in and described with respect to FIG. 2 below may not be mandatory and thus some may be omitted in certain embodiments. Additionally, some embodiments may include further or different components, devices or elements beyond those illustrated in and described with respect to FIG. 2.

The ATM apparatus 102 may include or otherwise be in communication with processing circuitry 210 that is configurable to perform actions in accordance with one or more example embodiments disclosed herein. In this regard, the processing circuitry 210 may be configured to perform and/or control performance of one or more functionalities of the ATM apparatus 102 in accordance with various example embodiments, and thus may provide means for performing functionalities of the ATM apparatus 102 in accordance with various example embodiments. The processing circuitry 210 may be configured to perform data processing, application execution and/or other processing and management services according to one or more example embodiments. In some embodiments, the ATM apparatus 102 or a portion(s) or component(s) thereof, such as the processing circuitry 210, may be embodied as or comprise a chip or chip set. In other words, the ATM apparatus 102 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The ATM apparatus 102 or the processing circuitry 210 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216, a communication interface 218, an ATM service controller 220, and/or a mobile device interface controller 222. As such, the processing circuitry 210 may be embodied as a circuit chip (e.g., an integrated circuit chip) configured (e.g., with hardware, software or a combination of hardware and software) to perform operations described herein.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the ATM apparatus 102 as described herein. The plurality of processors may be embodied on a single computing device or distributed across a plurality of computing devices collectively configured to function as the ATM apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the ATM apparatus 102. The memory 214 may be configured to store information, data, applications, instructions and/or the like for enabling the ATM apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents or data sets. Among the contents of the memory 214, applications may be stored for execution by the processor 212 in order to carry out the functionality associated with each respective application. In some cases, the memory 214 may be in communication with one or more of the processor 212, user interface 216, communication interface 218, ATM service controller 220, or mobile device interface controller 222 via a bus(es) for passing information among components of the ATM apparatus 102.

The user interface 216 may be in communication with the processing circuitry 210 to receive an indication of a user input at the user interface 216 and/or to provide an audible, visual, mechanical or other output to the user. As such, the user interface 216 may include, for example, a keyboard, a keypad, a mouse, a joystick, a display, a touch screen display, a microphone, a speaker, and/or other input/output mechanisms. As such, the user interface 216 may, in some example embodiments, provide means for facilitating ATM transactions. For example, the user interface 216 may provide means for user input such as a card reader (e.g., a debit/credit card reader), keypad, touch screen display, voice commands, and/or the like by which a user may enter account information, input information that may be needed for carrying out an ATM transaction, and/or the like. Additionally or alternatively, the user interface 216 may provide means for user input for utilizing services that may be provided by an ATM apparatus 102 of some example embodiments, such as for purchasing products. The user interface 216 may additionally or alternatively provide means for providing output to a user. In this regard, a display that may be provided by the user interface 216 may display transaction information, product offerings, advertising, and/or the like to the user. In some example embodiments, the user interface may take the form of an application based operating system that displays one or more applications “apps” that can be executed on the ATM apparatus 102. In some example embodiments, the user interface 216 may include a printer, which may print transaction receipts, advertising, coupons, and/or the like for a user.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable the ATM apparatus 102 to communicate with the backend apparatus 104 via the network 106. Accordingly, the communication interface 218 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods. As a further example, the communication interface 218 may be configured to support a data connection between the ATM apparatus 102 and a mobile device 108. For example, the communication interface 218 may support a wireless connection with a mobile device 108, such as via a Bluetooth connection, RF connection, IR connection, wireless USB connection, WLAN connection, and/or the like.

In some example embodiments, the processor 212 (or the processing circuitry 210) may be embodied as, include, or otherwise control an ATM service controller 220. As such, the ATM service controller 220 may be embodied as various means, such as circuitry, hardware, a computer program product comprising computer readable program instructions stored on a computer readable medium (for example, the memory 214) and executed by a processing device (for example, the processor 212), or some combination thereof. The ATM service controller 220 may be capable of communication with one or more of the memory 214, user interface 216, communication interface 218, or mobile device interface controller 222 to access, receive, and/or send data as may be needed to perform one or more of the functionalities of the ATM service controller 220 as described herein. In some example embodiments, the ATM service controller 220 may be configured to control operation of the user interface 216. Thus, for example, where the ATM service controller 220 is described to cause output of information, such as by causing display of advertising, causing printing of a receipt, and/or the like, it will be appreciated that the ATM service controller 220 may cause output of information by controlling the user interface 216 to output the information. Additionally or alternatively, in some example embodiments, the ATM service controller 220 may be configured to control operation of the communication interface 218. Thus, for example, where the ATM service controller 220 is described to cause information to be sent to another computing device, such as to the backend apparatus 104 over the network 106, it will be appreciated that the ATM service controller 220 may cause the information to be sent by controlling the user interface 216 to send the information.

In some example embodiments, the ATM apparatus 102 may include a mobile device interface controller 222, which may be embodied by and/or otherwise controlled by the processor 212 (or the processing circuitry 210) and/or by the ATM service controller 220. As such, the mobile device interface controller 222 may be embodied as various means, such as circuitry, hardware, a computer program product comprising computer readable program instructions stored on a computer readable medium (for example, the memory 214) and executed by a processing device (for example, the processor 212), or some combination thereof. The mobile device interface controller 222 may be configured to control and/or otherwise facilitate communication with a mobile device 108. In this regard, the mobile device interface controller 222 may be configured to ascertain an identity that may be asserted and/or otherwise presented by a mobile device 108, such as by reading a barcode, RF identifier (RFID), and/or other indication of a user identity that may be presented to an ATM apparatus 102 by a mobile device 108. Additionally or alternatively, the mobile device interface controller 222 may be configured to control the provision of information to a mobile device 108, such as the provision of a bar code, product voucher, digital ticket, and/or other data that may be used to redeem a product that may be purchased at an ATM apparatus 102 in some example embodiments. As such, the mobile device interface controller 222 of some example embodiments may be configured to control operation of the communication interface 218 to cause data to be transmitted to and/or received from a mobile device 108. In some example embodiments, the mobile device interface controller 222 may be capable of communication with one or more of the memory 214, user interface 216, communication interface 218, or ATM service controller 220 to access, receive, and/or send data as may be needed to perform one or more of the functionalities of the mobile device interface controller 222 as described herein.

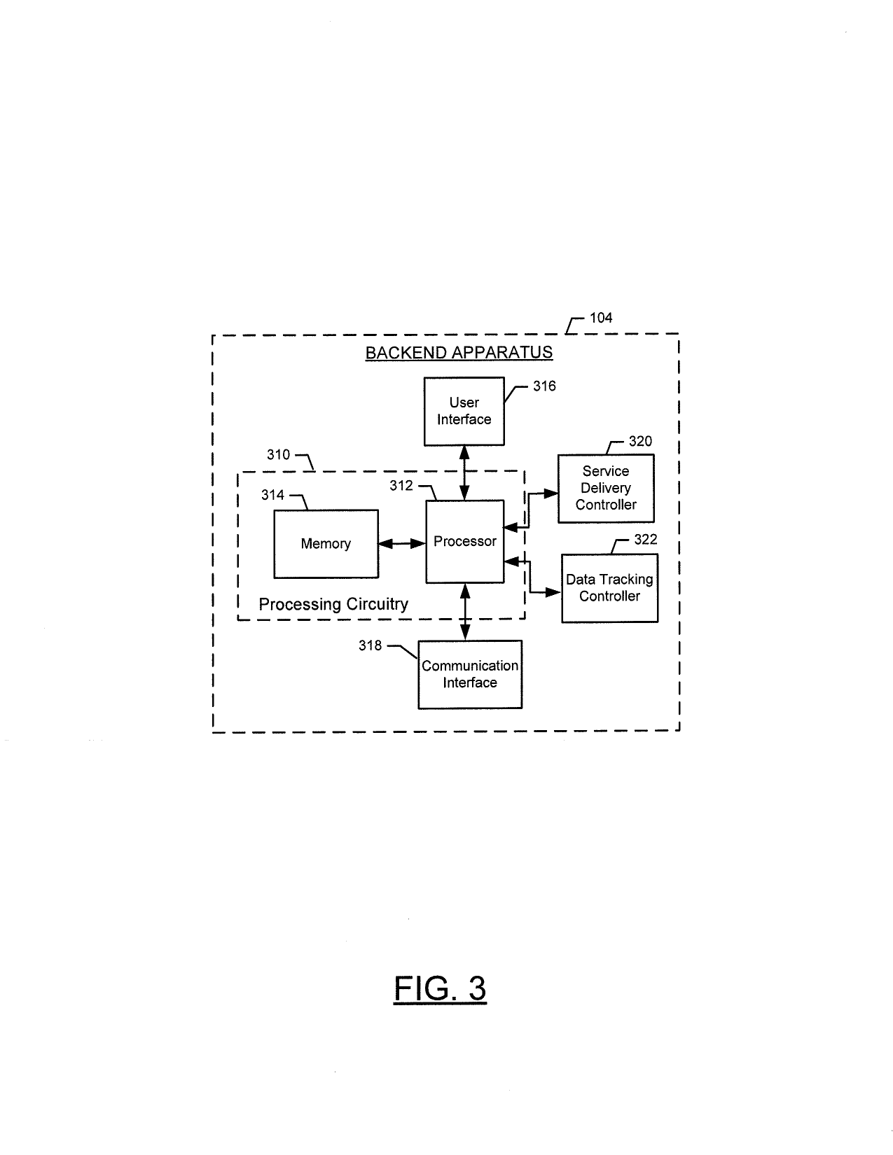

FIG. 3 illustrates a block diagram of a backend apparatus 104 in accordance with some example embodiments. However, it should be noted that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3.

The backend apparatus 104 may include or otherwise be in communication with processing circuitry 310 that is configurable to perform actions in accordance with one or more example embodiments disclosed herein. In this regard, the processing circuitry 310 may be configured to perform and/or control performance of one or more functionalities of the backend apparatus 104 in accordance with various example embodiments, and thus may provide means for performing functionalities of the backend apparatus 104 in accordance with various example embodiments. The processing circuitry 310 may be configured to perform data processing, application execution and/or other processing and management services according to one or more example embodiments. In some embodiments, the backend apparatus 104 or a portion(s) or component(s) thereof, such as the processing circuitry 310, may be embodied as or comprise a chip or chip set. In other words, the backend apparatus 104 or the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The backend apparatus 104 or the processing circuitry 310 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 310 may include a processor 312 and, in some embodiments, such as that illustrated in FIG. 3, may further include memory 314. The processing circuitry 310 may be in communication with or otherwise control a user interface 316, a communication interface 318, a service delivery controller 320, and/or a data tracking controller 322. As such, the processing circuitry 310 may be embodied as a circuit chip (e.g., an integrated circuit chip) configured (e.g., with hardware, software or a combination of hardware and software) to perform operations described herein.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 312 may comprise a plurality of processors. The plurality of processors may be in operative communication with each other and may be collectively configured to perform one or more functionalities of the backend apparatus 104 as described herein. The plurality of processors may be embodied on a single computing device or distributed across a plurality of computing devices collectively configured to function as the backend apparatus 104. In some example embodiments, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform one or more operations described herein.

In some example embodiments, the memory 314 may include one or more non-transitory memory devices such as, for example, volatile and/or non-volatile memory that may be either fixed or removable. In this regard, the memory 314 may comprise a non-transitory computer-readable storage medium. It will be appreciated that while the memory 314 is illustrated as a single memory, the memory 314 may comprise a plurality of memories. The plurality of memories may be embodied on a single computing device or may be distributed across a plurality of computing devices collectively configured to function as the backend apparatus 104. The memory 314 may be configured to store information, data, applications, instructions and/or the like for enabling the backend apparatus 104 to carry out various functions in accordance with one or more example embodiments. For example, the memory 314 may be configured to buffer input data for processing by the processor 312. Additionally or alternatively, the memory 314 may be configured to store instructions for execution by the processor 312. As yet another alternative, the memory 314 may include one or more databases that may store a variety of files, contents or data sets. Among the contents of the memory 314, applications may be stored for execution by the processor 312 in order to carry out the functionality associated with each respective application. In some cases, the memory 314 may be in communication with one or more of the processor 312, user interface 316, communication interface 318, service delivery controller 320, or data tracking controller 322 via a bus(es) for passing information among components of the backend apparatus 104.

In some example embodiments, the backend apparatus 104 may include a user interface 316. However, in some example embodiments, aspects of the user interface 316 may be limited, or the user interface 316 may be eliminated entirely. In embodiments wherein the backend apparatus 104 includes a user interface 316, the user interface 316 may be in communication with the processing circuitry 310 to receive an indication of a user input at the user interface 316 and/or to provide an audible, visual, mechanical or other output to the user. As such, the user interface 316 may include, for example, a keyboard, a mouse, a joystick, a display, a touch screen display, a microphone, a speaker, and/or other input/output mechanisms.

The communication interface 318 may include one or more interface mechanisms for enabling communication with other devices and/or networks. In some cases, the communication interface 318 may be any means such as a device or circuitry embodied in either hardware, or a combination of hardware and software that is configured to receive and/or transmit data from/to a network and/or any other device or module in communication with the processing circuitry 310. By way of example, the communication interface 318 may be configured to enable the backend apparatus 104 to communicate with one or more ATM apparatuses 102, one or more mobile devices 108, one or more user terminals 110, and/or other computing device(s) via the network 106. Accordingly, the communication interface 318 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the processor 312 (or the processing circuitry 310) may be embodied as, include, or otherwise control a service delivery controller 320. As such, the service delivery controller 320 may be embodied as various means, such as circuitry, hardware, a computer program product comprising computer readable program instructions stored on a computer readable medium (for example, the memory 314) and executed by a processing device (for example, the processor 312), or some combination thereof. The service delivery controller 320 may be capable of communication with one or more of the memory 314, user interface 316, communication interface 318, or data tracking controller 322 to access, receive, and/or send data as may be needed to perform one or more of the functionalities of the service delivery controller 320 as described herein. In some example embodiments, the service delivery controller 320 may be configured to control operation of the communication interface 318. Thus, for example, where the service delivery controller 320 is described to cause data to be sent to another computing device, such as to an ATM apparatus 102, mobile device 108, user terminal 110, and/or the like over the network 106, it will be appreciated that the service delivery controller 320 may cause the data to be sent by controlling the user interface 316 to send the data.

In some example embodiments, the processor 312 (or the processing circuitry 310) may be embodied as, include, or otherwise control a data tracking controller 322. As such, the data tracking controller 322 may be embodied as various means, such as circuitry, hardware, a computer program product comprising computer readable program instructions stored on a computer readable medium (for example, the memory 314) and executed by a processing device (for example, the processor 312), or some combination thereof. The data tracking controller 322 may be capable of communication with one or more of the memory 314, user interface 316, communication interface 318, or service delivery controller 320 to access, receive, and/or send data as may be needed to perform one or more of the functionalities of the data tracking controller 322 as described herein. In some example embodiments, the data tracking controller 322 may be configured to control operation of the communication interface 318. Thus, for example, where the data tracking controller 322 is described to cause data to be sent to another computing device, such as to an ATM apparatus 102, mobile device 108, user terminal 110, and/or the like over the network 106, it will be appreciated that the data tracking controller 322 may cause the data to be sent by controlling the user interface 316 to send the data.

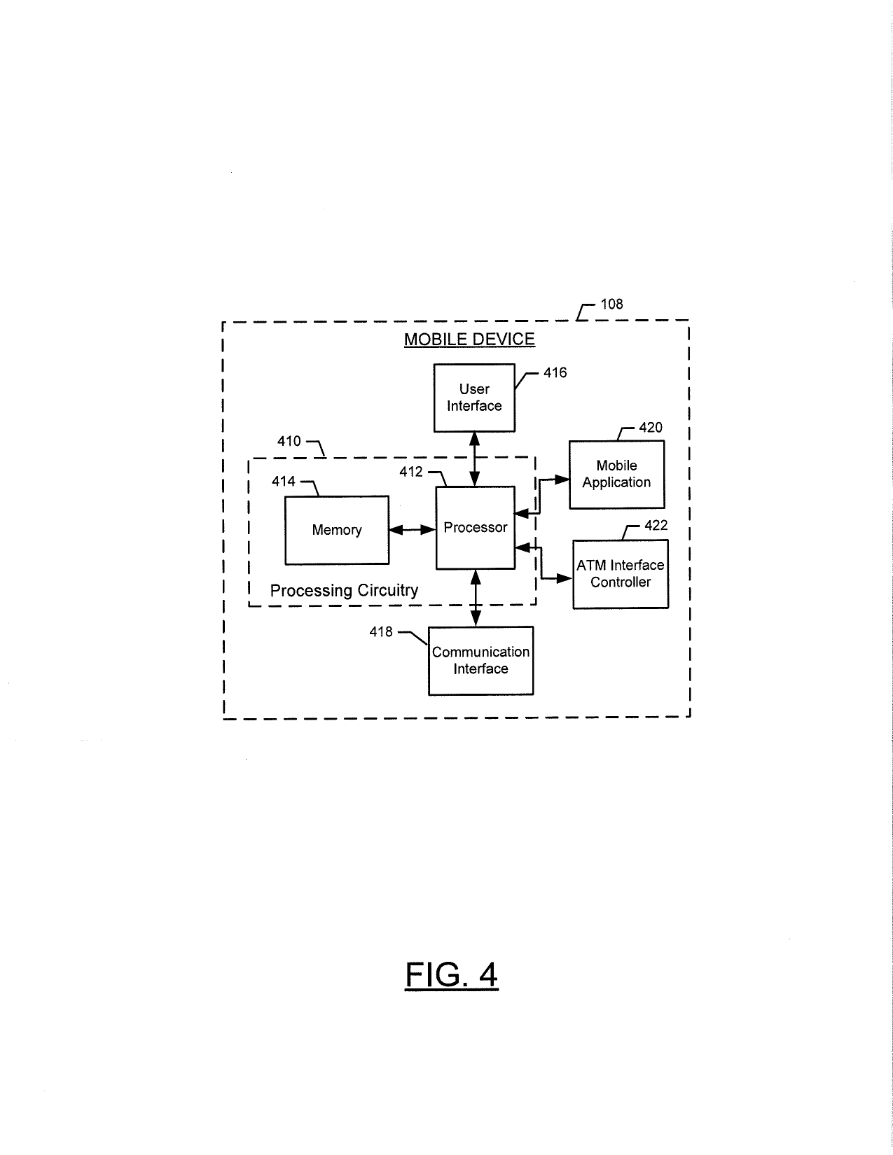

FIG. 4 illustrates a block diagram of a mobile device 108 in accordance with some example embodiments. However, it should be noted that the components, devices or elements illustrated in and described with respect to FIG. 4 below may not be mandatory and thus some may be omitted in certain embodiments. Additionally, some embodiments may include further or different components, devices or elements beyond those illustrated in and described with respect to FIG. 4.

The mobile device 108 may include or otherwise be in communication with processing circuitry 410 that is configurable to perform actions in accordance with one or more example embodiments disclosed herein. In this regard, the processing circuitry 410 may be configured to perform and/or control performance of one or more functionalities of the mobile device 108 in accordance with various example embodiments, and thus may provide means for performing functionalities of the mobile device 108 in accordance with various example embodiments. The processing circuitry 410 may be configured to perform data processing, application execution and/or other processing and management services according to one or more example embodiments. In some embodiments, the mobile device 108 or a portion(s) or component(s) thereof, such as the processing circuitry 410, may be embodied as or comprise a chip or chip set. In other words, the mobile device 108 or the processing circuitry 410 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The mobile device 108 or the processing circuitry 410 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 410 may include a processor 412 and, in some embodiments, such as that illustrated in FIG. 4, may further include memory 414. The processing circuitry 410 may be in communication with or otherwise control a user interface 416, a communication interface 418, a mobile application 420, and/or an ATM interface controller 422. As such, the processing circuitry 410 may be embodied as a circuit chip (e.g., an integrated circuit chip) configured (e.g., with hardware, software or a combination of hardware and software) to perform operations described herein.

The processor 412 may be embodied in a number of different ways. For example, the processor 412 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 412 may comprise a plurality of processors. The plurality of processors may be in operative communication with each other and may be collectively configured to perform one or more functionalities of the mobile device 108 as described herein. In some example embodiments, the processor 412 may be configured to execute instructions stored in the memory 414 or otherwise accessible to the processor 412. As such, whether configured by hardware or by a combination of hardware and software, the processor 412 may represent an entity (e.g., physically embodied in circuitry—in the form of processing circuitry 410) capable of performing operations according to embodiments of the present invention while configured accordingly. Thus, for example, when the processor 412 is embodied as an ASIC, FPGA or the like, the processor 412 may be specifically configured hardware for conducting the operations described herein. Alternatively, as another example, when the processor 412 is embodied as an executor of software instructions, the instructions may specifically configure the processor 412 to perform one or more operations described herein.

In some example embodiments, the memory 414 may include one or more non-transitory memory devices such as, for example, volatile and/or non-volatile memory that may be either fixed or removable. In this regard, the memory 414 may comprise a non-transitory computer-readable storage medium. It will be appreciated that while the memory 414 is illustrated as a single memory, the memory 414 may comprise a plurality of memories. The memory 414 may be configured to store information, data, applications, instructions and/or the like for enabling the mobile device 108 to carry out various functions in accordance with one or more example embodiments. For example, the memory 414 may be configured to buffer input data for processing by the processor 412. Additionally or alternatively, the memory 414 may be configured to store instructions for execution by the processor 412. As yet another alternative, the memory 414 may include one or more databases that may store a variety of files, contents or data sets. Among the contents of the memory 414, applications may be stored for execution by the processor 412 in order to carry out the functionality associated with each respective application. In some cases, the memory 414 may be in communication with one or more of the processor 412, user interface 416, communication interface 418, mobile application 420, or ATM interface controller 422 via a bus(es) for passing information among components of the mobile device 108.

The user interface 416 may be in communication with the processing circuitry 410 to receive an indication of a user input at the user interface 416 and/or to provide an audible, visual, mechanical or other output to the user. As such, the user interface 416 may include, for example, a keyboard, a mouse, a joystick, a display, a touch screen display, a microphone, a speaker, and/or other input/output mechanisms.

The communication interface 418 may include one or more interface mechanisms for enabling communication with other devices and/or networks. In some cases, the communication interface 418 may be any means such as a device or circuitry embodied in either hardware, or a combination of hardware and software that is configured to receive and/or transmit data from/to a network and/or any other device or module in communication with the processing circuitry 410. By way of example, the communication interface 418 may be configured to enable the mobile device 108 to communicate with the backend apparatus 104 via the network 106. Accordingly, the communication interface 418 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods. As a further example, the communication interface 418 may be configured to support a data connection between the mobile device 108 and an ATM apparatus 102. For example, the communication interface 418 may support a wireless connection with an ATM apparatus 102, such as via a Bluetooth connection, RF connection, IR connection, wireless USB connection, WLAN connection, and/or the like.

In some example embodiments, the processor 412 (or the processing circuitry 410) may be configured to control a mobile application 420. The mobile application 420 may comprise a computer program product comprising computer readable program instructions stored on a computer readable medium (for example, the memory 414) and executed by a processing device (for example, the processor 412). In this regard, the mobile application 420 may comprise an application that may be downloaded to and installed on the mobile device 108 to form a computer program product that may operate under control of the processing circuitry 410. It will be appreciated, however, that in some example embodiments, functionality attributed to the mobile application 420 may be at least partially executed by the backend apparatus 104 as a web service that may be accessed by the mobile device 108 via the network 106.

In some example embodiments, the mobile device 108 may include an ATM interface controller 422, which may be embodied by and/or otherwise controlled by the processor 412 (or the processing circuitry 410) and/or by the mobile application 420. As such, the ATM interface controller 422 may be embodied as various means, such as circuitry, hardware, a computer program product comprising computer readable program instructions stored on a computer readable medium (for example, the memory 414) and executed by a processing device (for example, the processor 412), or some combination thereof. The ATM interface controller 422 may be configured to control and/or otherwise facilitate communication with an ATM apparatus 102. In this regard, the ATM interface controller 422 may be configured to assert and/or otherwise present an identity that may be associated with the mobile device 108 and/or with a user thereof, such as by presenting a barcode, RF identifier (RFID), and/or other indication of a user identity that may be presented to an ATM apparatus 102. Additionally or alternatively, the ATM interface controller 422 may be configured to receive and/or send information from/to an ATM apparatus 102. As such, the ATM interface controller 422 of some example embodiments may be configured to control operation of the communication interface 418 to cause data to be transmitted to and/or received from an ATM apparatus 102. In some example embodiments, the ATM interface controller 422 may be capable of communication with one or more of the memory 414, user interface 416, communication interface 418, or mobile application 420 to access, receive, and/or send data as may be needed to perform one or more of the functionalities of the ATM interface controller 422 as described herein.

### Advertising-Supported Surcharge-Free ATM Transactions

In some example embodiments, the ATM service controller 220 may be configured to provide ATM transaction services to a user of the ATM apparatus 102. These ATM transaction services may comprise any service or transaction that may be provided via an ATM, such as, by way of non-limiting example, withdrawals, deposits, balance inquiries, and/or the like. The ATM transaction services provided by some example embodiments may be used by a cardholder of any financial services provider.

In some example embodiments, the ATM transaction services may be supported by the backend apparatus 104 (e.g., by the service delivery controller 320). For example, the backend apparatus 104 may be configured to provide transaction processing services. In this regard, the ATM service controller 220 may be configured to cause the ATM apparatus 102 to send transaction information (e.g., a card number, cardholder data, requested transaction information, and/or the like) to the backend apparatus 104 to enable the backend apparatus 104 to process a user-requested ATM transaction.

In some examples the transaction information may include a sixteen digit identification number that identifies the card so that the number can be electronically associated with a particular cardholder and also to the cardholder's designated bank account. The sixteen digit identification number may include a six-digit Issuer Identification Number (IIN), the first digit of which is the Major Industry Identifier (MII), a variable length (up to 12 digits) individual account identifier and a single check digit.

In accordance with some example embodiments, the ATM transaction services may be provided to a user without charging a surcharge fee. In this regard, the ATM service controller 220 of some example embodiments may be configured to cause third-party advertising to be presented to a user of the ATM apparatus 102 in lieu of charging a surcharge fee to the user and/or to the user's financial services provider. The third-party advertising may comprise any form of advertising for third-party products or services (e.g., advertising for an entity other than an operator of the ATM apparatus 102). The advertising may comprise still images, video, a slideshow, a scrolling advertisement, text-based advertising, an audio advertisement, a printed advertisement, a user survey, some combination thereof, or the like. Accordingly, by way of example, the advertising may be presented to the user by way of display on a display of the ATM apparatus 102, through play out of audio on a speaker that may be implemented on the ATM apparatus 102 in some example embodiments, by way of a printout that may be printed by a printer that may be implemented on the ATM apparatus 102, and/or the like.

In some example embodiments, advertising that may be presented to a user of the ATM apparatus 102 may be pre-loaded on the ATM apparatus 102. For example, advertising content may be physically uploaded to the ATM apparatus 102 on-site and stored in the memory 214. Additionally or alternatively, advertising content may be provided to the ATM apparatus 102 by the backend apparatus 104 (e.g., under control of the service delivery controller 320) over the network 106 and stored in the memory 214.

In some example embodiments, advertising that may be presented to a user of the ATM apparatus 102 may be delivered on-demand to the ATM apparatus 102 over the network 106 by the backend apparatus 104, such as under control of the service delivery controller 320. Accordingly, in some example embodiments, the service delivery controller 320 and ATM service controller 220 may work cooperatively to present advertising to a user of the ATM apparatus 102.

In some example embodiments, advertising may be presented prior to initiation of an ATM transaction. Advertising presented prior to initiation of a transaction may, for example, comprise a splash screen, screen saver, a rolling advertisement, a still image, video, audio, text, and/or the like that may be presented prior to a user initiating an ATM session, such as by inserting a card and/or otherwise asserting an identity to log onto the ATM apparatus 102. In some example embodiments, advertising may also be printed on decals, vinyl wraps, and/or the like that may be disposed upon an exterior housing of an ATM apparatus 102.

In some example embodiments, advertising may be additionally or alternatively presented during an ATM transaction. In this regard, advertising may be presented subsequent to a user inserting his or her card and/or otherwise asserting his or her identity to log onto the ATM apparatus 102 and initiate an ATM transaction. Advertising presented during an ATM transaction may be presented while a user selects a desired transaction, enters transaction information, while the transaction is being processed, while a transaction confirmation is displayed subsequent to completion of processing of the transaction, and/or the like. Advertising that may be presented during an ATM transaction may, for example, include a still image, a video, audio, text, and/or the like. In some example embodiments, the advertising may comprise interactive advertising such that a user may manipulate and/or otherwise interact with the presented advertising. For example, interactive advertising may include a customer feedback survey through which a user may be prompted for a response to one or more questions, which may be used by third-party advertisers to obtain customer opinions and feedback. Results of such surveys may be provided to the advertiser by the ATM apparatus 102 and/or by the backend apparatus 104.

In some example embodiments, advertising that may be presented during an ATM transaction may be presented only within a period of time during which the transaction may be processed. In this regard, advertising that may occupy an entirety of a display of the ATM apparatus 102 and/or otherwise inhibit a user from entering transaction information for engaging in an ATM transaction may be presented only while the ATM transaction is processing in some example embodiments so as to not extend a time that may be required for a user to complete an ATM transaction beyond a time that may be required if advertising were not presented to the user. Such example embodiments may accordingly provide a user with a surcharge-free ATM experience without occupying an additional portion of the user's time. In such example embodiments, the ATM service controller 220 and/or service delivery controller 320 may be configured to determine that processing of an ATM transaction and cause advertising to be presented to the user while the ATM transaction is being processed. Presentation of the advertising may be ceased in response to completion of processing of the ATM transaction.

In some example embodiments, advertising may be additionally or alternatively presented after completion of a transaction. Advertising presented after completion of a transaction may, for example, include a screen saver, a rolling advertisement, a still image, video, audio, text, and/or the like. In some example embodiments, advertising that may be presented after completion of a transaction may comprise a printed advertisement that may be printed by a printer that may be implemented on an ATM apparatus 102 in accordance with some example embodiments. For example, the advertisement may be printed on a transaction receipt and/or on a dedicated piece of paper that may be separate from a transaction receipt. The printed advertisement may, for example, comprise a printed advertisement for a product or service. Additionally or alternatively, the printed advertisement may comprise a coupon, promotional offer, and/or the like that may be redeemed for a discounted product or service. For example, the printed advertisement may include a barcode that may be presented to a vendor for a discounted product or service. Additionally or alternatively, as another example, the printed advertisement may include a web address, code, and/or the like that may be used online to obtain a discounted product or service. In some example embodiments, advertising that may be presented after completion of a transaction may be delivered to a user electronically (e.g., to a mobile device 108 that may be associated with the user), such as via email, text message, and/or the like.

In some example embodiments, an ATM that is otherwise configured to charge a surcharge for the use of the ATM may be modified to provide a surcharge free experience. For example, the ATM surcharge charging provision may be disabled by the ATM owner, provider, licensee or the like of the ATM and may instead enable the provision of advertising. As such, the provider, licensee or the like of the ATM may derive review that would otherwise be provided via the surcharge from advertising. In some examples, the provider, licensee or the like of the ATM may control the type of advertising that is displayed.

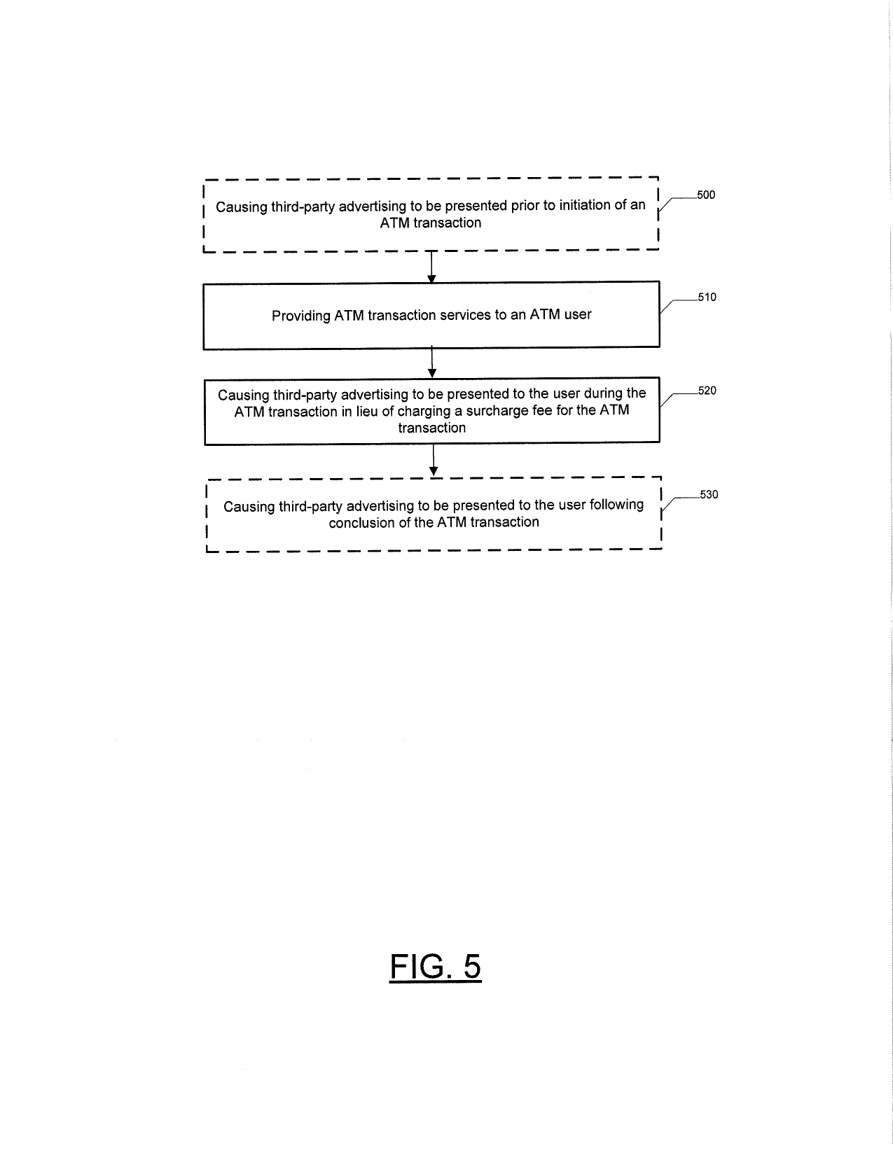

Referring now to FIG. 5, FIG. 5 illustrates a flowchart according to an example method for providing surcharge-free ATM transactions according to some example embodiments. In this regard, FIG. 5 illustrates operations that may be performed at an ATM apparatus 102. The operations illustrated in and described with respect to FIG. 5 may, for example, be performed by, with the assistance of, and/or under the control of one or more of the processing circuitry 210, processor 212, memory 214, user interface 216, communication interface 218, or ATM service controller 220. In some example embodiments, one or more of the operations illustrated in FIG. 5 may be performed with the support of the backend apparatus 104. Accordingly, in such example embodiments, one or more of the operations illustrated in and described with respect to FIG. 5 may, for example, be performed by, with the assistance of, and/or under the control of one or more of the processing circuitry 310, processor 312, memory 314, communication interface 318, service delivery controller 320, or data tracking controller 322.

The method of FIG. 5 may optionally include operation 500, which may comprise causing third-party advertising to be presented prior to initiation of an ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 500. Operation 510 may comprise providing ATM transaction services to an ATM user. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 510. Operation 520 may comprise causing third-party advertising to be presented to the user during the ATM transaction in lieu of charging a surcharge fee for the ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 520. The method may optionally additionally include operation 530, which may comprise causing third-party advertising to be presented to the user following conclusion of the ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 530.

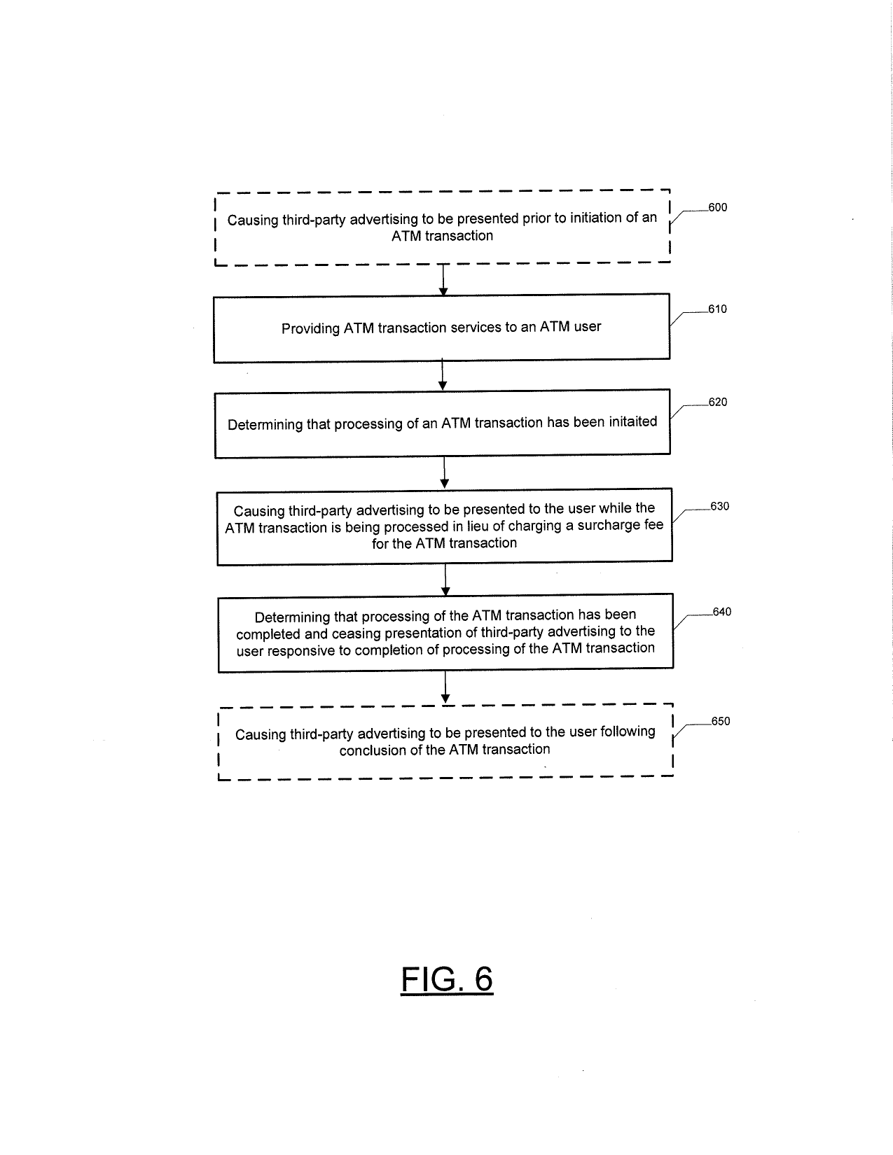

Referring now to FIG. 6, FIG. 6 illustrates a flowchart according to another example method for providing surcharge-free ATM transactions according to some example embodiments. In this regard, FIG. 6 illustrates operations that may be performed at an ATM apparatus 102. The operations illustrated in and described with respect to FIG. 5 may, for example, be performed by, with the assistance of, and/or under the control of one or more of the processing circuitry 210, processor 212, memory 214, user interface 216, communication interface 218, or ATM service controller 220. In some example embodiments, one or more of the operations illustrated in FIG. 6 may be performed with the support of the backend apparatus 104. Accordingly, in such example embodiments, one or more of the operations illustrated in and described with respect to FIG. 6 may, for example, be performed by, with the assistance of, and/or under the control of one or more of the processing circuitry 310, processor 312, memory 314, communication interface 318, service delivery controller 320, or data tracking controller 322.

The method of FIG. 6 may optionally include operation 600, which may comprise causing third-party advertising to be presented prior to initiation of an ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 600. Operation 610 may comprise providing ATM transaction services to an ATM user. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 610. Operation 620 may comprise determining that processing of an ATM transaction has been initiated. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 620. Operation 630 may comprise, responsive to the determination of operation 620, causing third-party advertising to be presented to the user while the ATM transaction is being processed in lieu of charging a surcharge fee for the ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 630. Operation 640 may comprise determining that processing of the ATM transaction has been completed and ceasing presentation of third-party advertising to the user responsive to completion of processing of the ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 640. The method may optionally additionally include operation 650, which may comprise causing third-party advertising to be presented to the user following conclusion of the ATM transaction. The processing circuitry 210, processor 212, memory 214, user interface 216, communication interface 218, ATM service controller 220, processing circuitry 310, processor 312, memory 314, communication interface 318, service delivery controller, and/or data tracking controller 322 may, for example, provide means for performing operation 650.

In some example embodiments, a user may be presented with the option to opt to pay a surcharge fee in lieu of being presented with at least a portion of advertising that may otherwise be presented prior to, during, and/or following an ATM transaction in lieu of the surcharge fee. In such example embodiments, the service delivery controller 320 may be configured to present a user with an option via the user interface 216 to opt to pay the surcharge fee rather than being presented with advertising. If the user does not opt to pay the surcharge fee, then advertising may be presented to the user in lieu of a surcharge fee being charged for the ATM transaction. If, however, the user opts to pay the surcharge fee instead of being presented with advertising, the user and/or the user's financial services provider may be charged a surcharge fee for the ATM transaction. For example, if the user opts to pay the surcharge fee, the ATM service controller 220 may be configured to inform the backend apparatus 104 that a surcharge fee is to be charged. The service delivery controller 320 may be configured in turn to debit the user's account for the surcharge fee and/or bill the user's financial services provider for the surcharge fee.

In some example embodiments, advertising that may be presented to a user of an ATM apparatus 102 may be targeted. For example, in some example embodiments, advertising that may be provided to an ATM apparatus 102 by the service delivery controller 320 may be selected based at least in part upon a location of the ATM apparatus 102. In this regard, ATM apparatuses 102 deployed in the system 100 may be divided into a plurality of location-dependent groups based at least in part upon their respective locations. ATM apparatuses 102 may, for example, be assigned to location-dependent groups based at least in part upon a physical region in which they are deployed. Thus, for example, an ATM apparatus 102 may be assigned to a group based at least in part on a zip code, city, state, geographic region, and/or the like in which the ATM apparatus 102 may be deployed. Additionally, or alternatively, ATM apparatuses 102 may be assigned to location-dependent groups based at least in part on a type of location in which they are deployed. For example, ATM apparatuses 102 deployed in night clubs, bars, shopping malls, offices, transportation stations, and/or the like may each constitute a separate location-dependent group of ATM apparatuses 102. In some example embodiments, an ATM apparatus 102 may be assigned to a location-dependent groups based at least in part on both a physical region of deployment and a type of location within which the ATM apparatus 102 is deployed.

A location-dependent group may be associated with a set of consumer demographics which may, for example, include a location, age range, sex, probability of a certain race, spending power, and/or other demographic factors that may be associated with the average user of an ATM assigned to the location-dependent group. Accordingly, advertising targeted to a demographic group that may be associated with a location-dependent group of ATM apparatuses 102 may be provided to ATM apparatuses 102 within the location-dependent group by the service delivery controller 320. Thus, for example, advertising that may be presented on an ATM apparatus 102 located in Los Angeles, Calif. may be different from advertising that may be presented on an ATM apparatus 102 located in Peoria, Ill. due to the difference in consumer demographics between Los Angeles and Peoria. As another example, advertising that may be presented on an ATM apparatus 102 located in a night club frequented by an average age range of 21-30 may be different from advertising that may be presented on an ATM apparatus 102 located in a suburban shopping mall frequented by 35-50 year old soccer moms. Accordingly, in some example embodiments, an advertiser may have its advertising selectively delivered to one or more siloed groups of ATMs based at least in part on the advertiser's target demographic.

In some example embodiments, advertising presented on an ATM apparatus 102 may be targeted to a current user of the ATM apparatus 102. In this regard, for example, a user of the ATM apparatus 102 may be identified based at least in part on a card (e.g., bank card, credit card, debit card, or the like) presented by the user to initiate an ATM transaction and/or other indication of the user's identity that may be provided in order to initiate an ATM transaction. The data tracking controller 322 may be configured to determine demographics, interests, and/or other information that may be associated with the user identity and deliver advertising for presentation on the ATM apparatus 102 that is specifically targeted to that user. For example, as will be described further herein below, the data tracking controller 322 of some example embodiments may be configured to maintain customer relationship management (CRM) data that may detail a user's prior usage of ATM apparatuses 102 in the system 100, including, for example, a record of previous ATM transactions, products or services purchased via an ATM apparatus 102, and/or the like. Advertising may accordingly be targeted to a user based at least in part on the CRM data that may be maintained for a user. As another example, in some example embodiments, the system 100 may be integrated with one or more social media networks such that the data tracking controller 322 may obtain information from a user's social media profile(s). This information may accordingly be used to determine a user's interests such that advertising may be targeted to the user's known interests.

Alternatively or additionally, in some example embodiments, advertising presented on an ATM apparatus 102 may be targeted based on a bank or issuer of an ATM card that is identified by the IIN of the ATM apparatus 102. In such cases particular advertisements or surcharges may be determined based on the issuer of the card.

In some example embodiments, the data tracking controller 322 may be configured to track advertisements presented on one or more ATM apparatuses 102 for accounting purposes. In this regard, in some example embodiments, advertisers may be charged based on a number of impressions presented (e.g., on a cost per thousand (CPM) impressions basis), on a per transaction basis (e.g., for each ATM transaction during which an advertiser's advertisement is presented), and/or on some other basis based at least in part on a number of times that the advertiser's advertisement(s) was presented. The data tracking controller 322 may accordingly be configured to track a number of times that an advertisement was presented and maintain accounting data in accordance with the advertiser's advertising agreement. The data tracking controller 322 may be configured to use the accounting data to bill an advertiser on and/or deduct from an advertiser's pre-paid advertising budget in accordance with the advertiser's advertising agreement.

In some embodiments, a user may be presented with the option to donate funds to a charity during an ATM transaction. For example, an option may be presented to a user at the start of a transaction and/or during a transaction via the user interface 216. In some example embodiments, if a user opts to make a donation, the donation may be made in lieu of the user being charged a surcharge fee. Additionally or alternatively, in some example embodiments, a user may opt to donate funds to a charity rather than being presented with advertising during an ATM transaction. Donated funds may, for example, be deducted from the user's account during the ATM transaction.

### Integration of an Order Taking Kiosk into an ATM

In some example embodiments, an ATM apparatus 102 may be configured to function as an order taking kiosk in addition to providing ATM transaction services. In this regard, some example embodiments provide an order taking management system allowing businesses such as nightclubs, bars and fast food restaurants to enable customers to place their orders for food or drinks from the bar or kitchen via an on-site ATM apparatus 102. Instead of having one bartender ringing up each customer, the bartender may focus more attention on fulfilling orders placed via an ATM apparatus 102 to ensure an orderly and efficient flow of operations. In such example embodiments, the ATM service controller 220 may be configured to provide a user with a list of items that may be purchased from a vendor. The list of items that may be purchased may be pre-loaded onto the ATM apparatus 102, such as in the memory 214 and/or may be provided to the ATM apparatus 102 (e.g., on demand) by the backend apparatus 104, such as under the control of the service delivery controller 320. For example, in a restaurant or bar location, a user may be provided with a menu of items that may be purchased, such as on a display of the user interface 216. A user may accordingly select items desired for purchase and place an order.

In some example embodiments, third-party advertising may be presented along with a list of items available for purchase. In some example embodiments, the advertising may be integrated into a menu of items. For example, if a menu of drinks that may be purchased from a bar is presented to a user is sponsored by a particular brand of vodka, each drink on the menu that includes vodka as an ingredient may list the drink as being made with the sponsoring brand of vodka.

In some example embodiments, the ATM service controller 220 may be configured to convey a customer order to a computing system that may be operated by the vendor. For example, the order may be conveyed to a point of sale system, order fulfillment system, order ticket printer, and/or other computing device that may be operated by the vendor to facilitate placement and/or fulfillment of orders. The order may be conveyed by any communication link by which the ATM apparatus 102 and a vendor computing device may be in communication, such as via the network 106, via a wired communication link, via a wireless communication link (e.g., Bluetooth, WLAN, IR, RF, and/or the like), and/or the like. As another example, a customer order may be forwarded to the backend apparatus 104 over the network 106, and the service delivery controller 320 may be configured to direct the customer order to the vendor computing device to facilitate order fulfillment.

In some example embodiments, a user may be provided with a voucher that may be redeemable for the order. For example, a confirmation receipt may be printed via a printer that may be integrated into the ATM apparatus 102 in some example embodiments. Additionally or alternatively, a digital voucher may be sent to the user, such as via text message, email, and/or the like. The user may accordingly present the voucher to claim his or her order.

In some example embodiments, a user may be able to make dinner reservations via an ATM apparatus 102. The reservations may, for example, be conveyed to the restaurant by the ATM service controller 220 via any communication link by which the ATM apparatus 102 and a restaurant computing device may be in communication, such as via the network 106, via a wired communication link, via a wireless communication link (e.g., Bluetooth, WLAN, IR, RF, and/or the like), and/or the like. Additionally or alternatively, a user's reservations may be forwarded to the backend apparatus 104 over the network 106, and the service delivery controller 320 may be configured to send the reservations to the restaurant computing device. In some example embodiments, a user may be place a food order in addition to making the reservations such that the user's order may be paid for and prepared in time for the user's arrival at the restaurant. Accordingly, when the user arrives at a restaurant, the user's table may be ready and the food order may be only minutes away. Alternatively, in takeout ordering scenarios, the user's food may be ready for takeout at the time of his or her arrival.

While the ordering kiosk provided by some example embodiments has been described by way of example in the context of restaurant and bar establishments, it will be appreciated that embodiments are not so limited. In this regard, embodiments providing an ordering kiosk integrated into an ATM apparatus 102 may enable the purchase of any type of product or service. For example, a user may browse a website or catalog that may be presented by the ATM service controller 220 via the user interface 216. The user may accordingly order products from the website or catalog that may be mailed to a user. As another example, a user may purchase tickets, such as event tickets (e.g., tickets to concerts, movies, sporting events, theater events, and/or the like), train tickets, airline tickets, and/or the like. In some example embodiments, purchased tickets may be printed by a printer that may be integrated into an ATM apparatus 102. As another example, purchased tickets may be delivered electronically to a user, such as via email, text messaging, and/or the like.

### Location-Based Offers

In some example embodiments, an ATM apparatus 102 may be configured to enable a user to purchase location-based offers. The location-based offers may be limited time offers, which may periodically change. For example, the location-based offers may comprise “daily deals” that may change on a daily basis. Customers may be able to buy a limited time location-based offer up until the designated time that a vendor wants to end the special. In some example embodiments, location-based offers that are redeemable for food, services, and/or the like may be redeemed within a designated time frame (e.g., by a designated expiration date/time) that may be imposed by the vendor.

A location-based offer may be unique to a particular location(s) of an ATM apparatus(es) 102. In this regard, a location-based offer in accordance with some example embodiments may only be purchased by visiting a particular ATM location(s) through which the offer may be offered for sale.

The service delivery controller 320 may be configured to selectively control location-based offers that may be offered by respective ATM apparatuses 102. The ATM service controller 220 of an ATM apparatus 102 may in turn be configured to present an option for a user to purchase a location-based offer that is offered by the respective ATM apparatus 102. In some example embodiments, upon completion of a transaction, buyers can choose where and how to send a purchased location-based offer. For example, if the location-based offer is a physical product, a user may input an address to which the product may be shipped and an associated vendor may fulfil the order. If, the location-based offer is a service, discount coupon, ticket, and/or the like, the user may select to have a voucher delivered electronically, such as via email, text messaging, and/or the like.

In some example embodiments, the service delivery controller 320 may be configured to provide a website through which users may locate ATM apparatuses 102 and browse location-based offers that may be purchased at various locations. The website may, for example, be accessed by a mobile device 108, user terminal 110, and/or the like to enable a user to purchase a daily deal. Additionally or alternatively, the mobile application 420 that may be implemented on a mobile device 108 in accordance with some example embodiments may provide a locator by which a user may locate ATM apparatuses 102 and browse location-based offers that may be purchased at various locations.

In some example embodiments, a user may be notified, such as via email, text messaging, and/or the like of location-based offers that may be within a predefined proximity of the user's location, residence, or the like. Additionally or alternatively, in some example embodiments, a user may be notified, such as via email, text messaging, and/or the like of location-based offers that may match a user's known interests, such as based on prior purchasing habits, CRM data that may be maintained for the user by the data tracking controller 322 of some example embodiments, user interests that may be specified in a user profile, and/or the like. As such, location-based offers provided by some example embodiments may be used as a marketing tool for advertising by allowing a merchant to dictate the deal. The merchant dictated deal may be sent out to users of the system 100 to drive customers to specific ATM locations based on time of the day, the deal offered, and/or other factors.

In some example embodiments, a user may reserve a location-based offer via a web interface and/or via the mobile application 420. However, the user may still have to physically go to the ATM location through which the reserved location-based offer is offered in order to complete the purchase of and claim the location-based offer.

In some example embodiments, daily deals that may be offered by third-party daily deal providers may be aggregated by the ATM service controller 220 and/or service delivery controller 320 and presented via the user interface 216 for purchase at an ATM apparatus 102.

### Customer Relationship Management (CRM) Data

In some example embodiments, the data tracking controller 322 may be configured to derive and maintain CRM data for users of the system 100. In this regard, when a customer uses an ATM apparatus 102, the customer may be authenticated through a series of debit card identifiers such that customer history (e.g., personal preferences, prior purchasing habits, and/or the like) may be maintained in the form of CRM data. In various example embodiments, authentication may comprise a debit card number, a portion of a debit card number, email address, user name, password, zip code, name, some combination thereof, or the like.

The maintained CRM data may, for example, include information about products, services, location-based offers, and/or the like that may have previously been purchased by a customer from an ATM apparatus 102. As another example, the CRM data may additionally or alternatively comprise user responses to interactive surveys.

In some example embodiments, the service delivery controller 320 and/or ATM service controller 220 may be configured to utilize CRM data that may be maintained by the data tracking controller 322 to deliver targeted product and service offerings to a user, deliver targeted location-based offers to a user, present targeted advertising content to a user, and/or the like.

As such, in some example embodiments, as users continue to frequent ATM locations, proprietary CRM data may be derived and used to increase customer loyalty, repeat usage, and to drive sales. In some example embodiments, the more a user uses and purchases from ATM apparatuses 102 provided in accordance with some example embodiments, the more accurate the CRM data, and, consequently, provided personalized services may become.

In some example embodiments, CRM data may be used to track a number of times that a user has checked into an ATM location, a number and/or value of products or services purchased via an ATM apparatus(es) 102, and/or the like. In this regard, in some example embodiments, users may be rewarded with discounts, promotional offers, reward points, and/or the like for frequent use of ATM apparatuses 102 of the system 100. Accordingly, as a user uses ATM apparatuses 102, such as to purchase products or services, purchase location-based offers, engage in ATM transactions, and/or use other services that may be provided via an ATM apparatus 102 in accordance with various example embodiments, the user may accumulate reward points and/or be rewarded with discounts, promotional offers, and/or the like. For example, a user may be rewarded for meeting threshold usage frequency criteria, making at least a threshold number of purchases, purchasing at least a certain threshold value of goods or services, and/or satisfying some other predefined criteria.

### Application-Based ATM Interface

In some example embodiments, an ATM apparatus 102 may be configured with an application-based interface. In this regard, the ATM apparatus 102 may be configured with an application-based operating system that may enable applications (e.g., “apps”) to be installed on the ATM apparatus 102 to increase functionality of the ATM apparatus 102. For example, a ticket application may be installed on an ATM apparatus 102 of some example embodiments to add functionality to enable a user to purchase tickets. As another example, a navigation application may be installed on the ATM apparatus 102 of some example embodiments to enable the ATM apparatus 102 to be used as a navigation kiosk. A user of an ATM apparatus 102 configured with an application-based interface may accordingly browse or scroll through installed applications to select a desired functionality or service that may be provided by the ATM apparatus 102.

### Mobile Device Integration

In some example embodiments, a mobile device 108 and ATM apparatus 102 may be configured to wirelessly interface with each other. In this regard, the mobile device interface controller 222 that may be implemented on an ATM apparatus 102 in accordance with some example embodiments and the ATM interface controller 422 that may be implemented on a mobile device 108 in accordance with some example embodiments may be configured to support interfacing between an ATM apparatus 102 and mobile device 108 such that data may be wirelessly communicated between a mobile device 108 and ATM apparatus 102. For example, in some example embodiments, users may be able to identify themselves to an ATM apparatus 102 through data that may be conveyed to the ATM apparatus 102 via a mobile device 108, such an RFID, an identification conveyed via Near Field Communication, Quick Response Code, an identification conveyed via Bluetooth technology, and/or the like. Accordingly, a user may use a mobile device 108 in accordance with some example embodiments to log onto an ATM apparatus 102 to receive special offers targeted to the user, engage in ATM transactions, and/or the like.

Further, in some example embodiments, a voucher, coupon, and/or the like may be wirelessly communicated from an ATM apparatus 102 to a user's mobile device 108. In this regard, in some example embodiments, if a user purchases a product or service, places an order, and/or the like, a voucher, barcode, and/or other proof of purchase that may be presented to a vendor in order to claim a purchased product, service, order, and/or the like.

Additionally or alternatively, as previously discussed, in some example embodiments, a mobile application 420 may be implemented on a mobile device 108. By way of example, the mobile application 420 may be downloaded to a mobile device 108 from a web interface that may be provided by the backend apparatus 104 of some example embodiments, from a third-party application store, and/or the like. The downloaded mobile application 420 may then be installed on the mobile device 108.

In some example embodiments, the mobile application 420 may enable users to locate ATM apparatuses 102, such as by GPS location, street address, and/or other system for identifying a physical location. In some example embodiments, the mobile application 420 may enable a user to browse real-time location-based offers for respective ATM locations. In some example embodiments, the mobile application 420 may be configured to enable a user to reserve a location-based offer offered by a particular ATM apparatus 102 so that the user may later go to the ATM apparatus 102 and claim the reserved offer.

In some example embodiments, advertisements for downloadable mobile applications may be delivered to a mobile device 108 by the mobile device interface controller 222 and/or the service delivery controller 320, such as during an ATM interaction and/or when the mobile device 108 is otherwise within sufficient proximity of an ATM apparatus 102. In this regard, a text message, email, and/or other communication may be sent to the mobile device 108. The communication may include information regarding a downloadable application and a link for downloading the application. If a user selects to download the application, the operating system of the mobile device 108 may be automatically determined and/or the user may be prompted to select the operating system. The appropriate application for the determined operating system may be installed. If the application is provided by a curated application store, the user may be taken to the appropriate application store for the determined operating system such that the proper application may be downloaded.

In some example embodiments, if a user views information regarding an advertisement, location-based offer, daily deal, and/or the like on an ATM apparatus 102, an ordering kiosk that may be integrated into the system 100, user terminal 110, and/or other computing device that the user is interested in viewing in further detail or considering at a later time, the user may select to “tag” the information and have the information “pushed” to his or her mobile device 108. Thus, for example, in some example embodiments, if the user selects to “tag” information regarding an advertisement, location-based offer, daily deal, and/or the like, the service delivery controller 320 may be configured to text, email, and/or otherwise convey (e.g., “push”) the tagged information to the user's mobile device 108.

### Social Media Tie-In

In some example embodiments, a user's social media profile may be used to provide customized services and experience to a user. For example, in some example embodiments, the ATM service controller 220, service delivery controller 320, and/or data tracking controller 322 may be configured to access a social media profile for a user to determine user interests that may be used to provide targeted advertising, targeted offers for products or services, and/or the like to a user of an ATM apparatus 102.

In accordance with various example embodiments, information may be accessed from a third-party social media platform, such as Facebook®, Twitter®, Google+®, Foursquare®, and/or the like. Additionally or alternatively, in some example embodiments, users of the system 100 may (e.g., optionally) maintain profiles that may be proprietary to the system 100, which may be used to determine user interests and/or the like that may be used to provide a user with a customized experience.

In some example embodiments, a user's social media profile may be tied to a user identification that may be provided to log onto an ATM apparatus 102. In this regard, by way of non-limiting example, a user's social media profile may be associated with a user's debit card number, a portion of the user's debit card number, a user name, an indication of identity that may be asserted via a mobile device 108, and/or other identification that may be used to uniquely identify the user within the context of the system 100.

In some example embodiments, a user's activities within the context of the system 100 may be published to the user's social media profile. For example, in some example embodiments, if a user checks into an ATM location, purchases a product or service, and/or performs some other action on an ATM apparatus 102, an indication of the performed action, such as a tweet, a status update, and/or the like may be automatically published to the user's social media profile(s) by the ATM service controller 220 and/or the service delivery controller 320. In some such example embodiments, a user may be able to configure privacy controls to select what types of actions may be published to the user's social media network and/or which of the user's friends or contacts may be able to see the published updates.

### Use of an ATM as an Information Distribution Point

In some example embodiments, an ATM apparatus 102 may be configured to serve as an information distribution point. In this regard, an ATM apparatus 102 in accordance with some example embodiments may be used a community, government agency, and/or the like to distribute public interest information, such as information about school closings; emergency messages from federal, state, and/or local officials; and/or other information that may be of public interest. This public interest information may, for example, be syndicated to one or more selected ATM apparatuses 102 by the service delivery controller 320.

### Rewards

In some example embodiments, ATM apparatuses 102 may be configured to integrate with the network 106 to facilitate generate rewards when one or more services are performed on ATM apparatuses 102 in accordance with various example embodiments. For example, in some example embodiments and in an instance in which a user uses an ATM apparatus 102 or another apparatus related to the service provided by the surcharge free ATM apparatus, the user may be provided with one or more rewards points. The rewards points may be redeemable for items, for ATM services, for a cash value and/or the like.

### Integration of other Computing Devices with the ATM Network

In some example embodiments, non-ATM apparatuses 102 may be configured to integrate with the network 106 to facilitate the purchase of products and services, order placement, and/or other activities that may be performed on ATM apparatuses 102 in accordance with various example embodiments. For example, in some example embodiments, consoles, such as may be integrated with the network 106, may be placed at various locations within a facility to enable a user to purchase products or services, place an order, and/or the like. As an example, consoles may be integrated into seats, booths, tables, and/or other furniture within a bar or restaurant to enable a customer to place a food or drink order. As a further example, consoles may be distributed throughout an office or apartment building to enable residents or workers to place orders for food, products, services, and/or the like.

Accordingly, it will be appreciated that in some example embodiments, a variety of computing devices may be integrated with the network 106 to enable the purchase of products and services that may be offered via an ATM apparatus 102 in accordance with some example embodiments. These computing devices may, for example, be configured to interface with the backend apparatus 104 over the network 106. In this regard, the service delivery controller 330 may, for example, be configured to provide customized content, targeted product offerings, and/or the like to computing devices that may interface with the backend apparatus 104 over the network 106.

### CONCLUSION

FIGS. 5 and 6 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device storing instructions executable by a processor in the computing device. In some example embodiments, the computer program instructions of the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a mobile data capture apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing an ATM transaction service to an ATM user; and
causing third-party advertising to be presented to the user during the ATM transaction service in lieu of charging a surcharge fee for the ATM transaction service.

2. A method according to claim 1, further comprising:
causing a selection of one or more targeted advertising based on at least one of: demographics associated within a location in which the ATM transaction service is deployed, time of day, or day of week.

3. A method according to claim 1, further comprising:
causing a selection of one or more advertising based on ATM user data related to at least one of: past transaction data, past purchase data, home address data, or social network data.

4. A method according to claim 1, further comprising:
causing third-party advertising to be presented prior to initiation of the ATM transaction service.

5. A method according to claim 1, further comprising:
causing third-party advertising to be presented following conclusion of the ATM transaction service.

6. A method according to claim 1, further comprising:
allowing an ATM user to purchase a product or service during or after the provided ATM transaction service.

7. A method according to claim 1 wherein the presenting of the third party advertising adds no additional time to the ATM transaction service.

8. An apparatus comprising at least one processor and at least one memory including computer program code, the at least one memory and the computer program code configured to, with the processor, cause the apparatus to at least:
provide an ATM transaction service to an ATM user; and
cause third-party advertising to be presented to the user during the ATM transaction service in lieu of charging a surcharge fee for the ATM transaction service.

9. An apparatus according to claim 8 wherein the at least one memory and the computer program code are further configured to, with the processor, cause the apparatus to:
cause a selection of one or more targeted advertising based on at least one of: demographics associated within a location in which the ATM transaction service is deployed, time of day, or day of week.

10. An apparatus according to claim 8 wherein the at least one memory and the computer program code are further configured to, with the processor, cause the apparatus to:
cause a selection of one or more advertising based on ATM user data related to at least one of: past transaction data, past purchase data, home address data, or social network data.

11. An apparatus according to claim 8 wherein the at least one memory and the computer program code are further configured to, with the processor, cause the apparatus to:
cause third-party advertising to be presented prior to initiation of the ATM transaction service.

12. An apparatus according to claim 8 wherein the at least one memory and the computer program code are further configured to, with the processor, cause the apparatus to:
cause third-party advertising to be presented following conclusion of the ATM transaction service.

13. An apparatus according to claim 8 wherein the at least one memory and the computer program code are further configured to, with the processor, cause the apparatus to:
allow an ATM user to purchase a product or service during or after the provided ATM transaction service.

14. An apparatus according to claim 8 wherein the presenting of the third party advertising adds no additional time to the ATM transaction service.

15. An apparatus comprising at least one processor and at least one memory including computer program code, the at least one memory and the computer program code configured to, with the processor, cause the apparatus to at least:
providing an ATM transaction service to an ATM user; and
causing third-party advertising to be presented to the user during the ATM transaction service in lieu of charging a surcharge fee for the ATM transaction service.

16. A computer program product according to claim 15 wherein the computer-readable program instructions further comprise program instructions configured for:
causing a selection of one or more targeted advertising based on at least one of: demographics associated within a location in which the ATM transaction service is deployed, time of day, or day of week.

17. A computer program product according to claim 15 wherein the computer-readable program instructions further comprise program instructions configured for:
causing a selection of one or more advertising based on ATM user data related to at least one of: past transaction data, past purchase data, home address data, or social network data.

18. A computer program product according to claim 15 wherein the computer-readable program instructions further comprise program instructions configured for:
causing third-party advertising to be presented prior to initiation of the ATM transaction service, wherein the presenting of the third party advertising adds no additional time to the ATM transaction service.

19. A computer program product according to claim 15 wherein the computer-readable program instructions further comprise program instructions configured for:
causing third-party advertising to be presented following conclusion of the ATM transaction service, wherein the presenting of the third party advertising adds no additional time to the ATM transaction service.

20. A computer program product according to claim 15 wherein the computer-readable program instructions further comprise program instructions configured for:
allowing an ATM user to purchase a product or service during or after the provided ATM transaction service.
